(19) United States
(12) Patent Application Publication
(10) Pub. No.: US 2017/0354837 A1
(43) Pub. Date: Dec. 14, 2017

(54) DESTRUCTION OF DENSE NONAQUEOUS PHASE LIQUIDS (DNAPLS) USING A TIME-RELEASE FORMULATION

(71) Applicant: WASHINGTON STATE UNIVERSITY, Pullman, WA (US)

(72) Inventor: Richard J. WATTS, Pullman, WA (US)

(21) Appl. No.: 15/532,593

(22) PCT Filed: Dec. 3, 2015
(86) PCT No.: PCT/US15/63591

§ 371 Date: Jun. 2, 2017

Related U.S. Application Data
(60) Provisional application No. 62/088,447, filed on Dec. 5, 2014.

(51) Int. Cl. A62D 3/38; C02F 1/72; B09C 1/08; B09C 1/00; A62D 101/22; C02F 101/36

(52) U.S. Cl. CPC A62D 3/38; B09C 1/08; B09C 1/002; C02F 1/722; C02F 2305/023; C02F 2101/363; C02F 2101/36; A62D 2101/22; B09C 2101/00

(57) ABSTRACT

Formulations and methods for destroying dense non-aqueous phase liquids (DNAPLs) using in situ chemical oxidation (ISCO) are provided. In particular, the invention provides slow release formulations comprising oxidants such as percarbonate and persulfate that efficiently destroy DNAPLs e.g. at sites requiring clean-up due to the presence of toxic DNAPL contaminants.

### CROSS-REFERENCE TO RELATED APPLICATIONS

This application claims benefit of U.S. provisional patent application 62/088,447, filed Dec. 5, 2014, the complete contents of which is hereby incorporated by reference.

### BACKGROUND OF THE INVENTION

### Field of the Invention

The invention generally relates to improved formulations and methods for destroying dense non-aqueous phase liquids (DNAPLs) via in situ chemical oxidation (ISCO). In particular, the invention provides time-release formulations comprising oxidants that generate reactive species that efficiently destroy DNAPLs e.g. at sites with subsoil contamination.

### Background

Improper disposal of hazardous organic chemicals has resulted in over 91,000 contaminated sites throughout the United States. At least 40,000 of these sites are contaminated with dense nonaqueous phase liquids (DNAPLs), which are pools of nearly pure chlorinated organic compounds (e.g., trichloroethylene, perchloroethylene, and dozens of other contaminants) that form a separate phase in the groundwater because of their low water solubilities. An effective process for DNAPL treatment has not been developed; the only treatment pathway to date relies on dissolution of the DNAPL into the surrounding groundwater and treatment of the dissolved contaminants in the aqueous phase. Such dissolution-limited treatment requires centuries for the complete cleanup of DNAPLs.

Contaminated sites are often treated using in situ chemical oxidation (ISCO) technologies in which oxidants, such as hydrogen peroxide or sodium persulfate, are injected into the subsurface. Most contaminated sites are flooded with chemical oxidants during ISCO cleanup projects; typical ranges of oxidant masses delivered to the subsurface range from 50,000 to 1,000,000 pounds of oxidant, depending on the volume of contamination and the mass of the contaminants present. Although these processes are often effective in treating contaminated sites where contaminants exist in the aqueous phase, they are rarely effective when DNAPLs are present because reactive species such as hydroxyl radical are capable of degrading DNAPL contaminants only when the contaminants have dissolved into the aqueous phase.

There is a need in the art to develop more efficient compositions and methods for destroying DNAPL contaminants

### SUMMARY OF THE INVENTION

Other features and advantages of the present invention will be set forth in the description of invention that follows, and in part will be apparent from the description or may be learned by practice of the invention. The invention will be realized and attained by the compositions and methods particularly pointed out in the written description and claims hereof.

Provided herein are time-release formulations for the destruction of DNAPLs, and ISCO methods for eliminating or eradicating DNAPLs using the formulations. The formulations include a first oxidizer which generates superoxide as a transient species and a second oxidizer which generates hydroxyl radicals as a transient species. One or both of the first and second oxidizers are associated with a slow-release matrix, from which they are released over time. Generally, at least the oxidizer that generates superoxide is present in a stabilized or slow release formulation. The transient superoxide and hydroxyl radicals that are generated promote dissolution and breakdown of DNAPLs with which they come into contact. In some aspects, the first oxidizer is percarbonate (PC) and the second oxidizer is persulfate (PS).

It is an object of this invention to provide compositions for destruction of dense nonaqueous phase liquids. The compositions comprise: a first slow release matrix comprising a first oxidizer which generates superoxide as a transient species, wherein the first oxidizer is released from the first slow release matrix over time; a second oxidizer which generates hydroxyl radicals as a transient species; and a liquid carrier. In some aspects, the first oxidizer is selected from the group consisting of sodium percarbonate, sodium perborate, and potassium superoxide. In other aspects, the second oxidizer is selected from the group consisting of sodium persulfate, calcium peroxide, sodium peroxymonocarbonate, stabilized hydrogen peroxide, and an organic peroxide. In yet other aspects the organic peroxide is tent-butyl peroxide. In other aspects, the second oxidizer is dissolved in said liquid carrier. In further aspects of the invention, the second oxidizer is present in the composition in a second slow release matrix. In further aspects, the second oxidizer is present in the composition in the first slow release matrix. In yet other aspects, the first oxidizer is sodium percarbonate in a slow release crystalline form. In other aspecs, one or both of the first and second slow release matrices are selected from the group consisting of a slow release matrix comprising attapulgite clay, ethyl cellulose, and sodium carboxymethylcellulose; silicate polymers, paraffins, and crosslinked starch.

The invention further provides methods of destroying dense nonaqueous phase liquids. The methods comprise: contacting the dense nonaqueous phase liquids with a composition comprising i) a first slow release matrix comprising a first oxidizer which generates superoxide as a transient species, wherein the first oxidizer is released from the first slow release matrix over time; and a second oxidizer which generates hydroxyl radicals as a transient species. The step of contacting is performed with a quantity of the composition that is sufficient to destroy the dense nonaqueous phase liquids. In some aspects, the dense nonaqueous phase liquids are present in soil. In other aspects, the dense nonaqueous phase liquids are present in water. In further aspects, the nonaqueous phase liquids are chlorinated organic compounds. The chlorinated organic compounds may be selected from the group consisting of a chlorinated solvent, coal tar, creosote, a polychlorinated biphenyl (PCB); a chlorobenzene, a chlorophenol, a chloroaniline, hexachlorocyclopentadiene and an extra heavy crude oil with an American Petroleum Institute (API) gravity of less than 10. In some aspects, the chlorinated solvent is selected from the group consisting of trichloroethylene, perchloroethylene, 1,1,1-trichloroethane, 1,1,2-trichloroethane, chloroform, methylene chloride, 1,2-dichloroethane, 1,2-dichloropropane, and carbon tetrachloride. In further aspects, the chlorobenzene is selected from the group consisting of chlorobenzene, 1,2-dichlorobenzene, 1,3-dichlorobenzene and 1,4-dichlorbenzene. In yet further aspects, the chlorophenol is 2-chlorophenol. In additional aspects, the chloroaniline is 2-chloroaniline.

### BRIEF DESCRIPTION OF THE DRAWINGS

FIGS. 1 and B. Destruction in percarbonate system of A, carbon tetrachloride; B, perchloroethylene.

FIGS. 2A and B. Hydrogen peroxide (%) and pH in A, the carbon tetrachloride-percarbonate system; and B, the perchloroethylene-percarbonate system.

FIGS. 3A and B. Destruction in percarbonate-activated persulfate systems of A, carbon tetrachloride; and B, perchloroethylene

FIGS. 4A and B. Persulfate (%) in A, carbon tetrachloride-percarbonate-activated persulfate systems; and B, in perchloroethylene-percarbonate-activated persulfate systems.

FIGS. 5A and B. Hydrogen peroxide (%) in A, carbon tetrachloride-percarbonate-activated persulfate systems; and B, perchloroethylene-percarbonate-activated persulfate systems.

FIGS. 6A and B. pH in A, carbon tetrachloride-percarbonate-activated persulfate systems; and B, perchloroethylene-percarbonate-activated persulfate systems.

FIGS. 7A and B. Destruction in soil-percarbonate systems of A, carbon tetrachloride; and B, perchloroethylene.

FIGS. 8A and B. Hydrogen peroxide (%) and pH in A, the carbon tetrachloride-soil-percarbonate systems; and B, the perchloroethylene-soil-percarbonate systems.

FIGS. 9A and B. Destruction in soil-stabilized percarbonate-persulfate systems of A, carbon tetrachloride; and B, perchloroethylene.

FIGS. 10A and B. Persulfate (%) in A, carbon tetrachloride-soil-stabilized percarbonate-persulfate systems; and B, perchloroethylene-soil-stabilized percarbonate-persulfate systems.

FIGS. 11A and B. Hydrogen peroxide (%) in A, carbon tetrachloride-soil-stabilized percarbonate-persulfate systems; and B, perchloroethylene-soil-stabilized percarbonate-persulfate systems.

FIGS. 12A and B. pH in A, carbon tetrachloride-soil-stabilized percarbonate-persulfate systems; and B, perchloroethylene-soil-stabilized percarbonate-persulfate systems.

### DETAILED DESCRIPTION

The transient oxygen species superoxide has surfactant properties that disrupt DNAPLs and enhance their rate of dissolution into an aqueous phase, providing a pathway for their rapid destruction. Superoxide is also highly reactive with respect to the breakdown of chloroalkanes, such as carbon tetrachloride; however, it exhibits minimal reactivity with chlorinated alkenes, such as perchloroethylene. In contrast, hydroxyl radical is a strong oxidant that oxidizes perchloroethylene, but not carbon tetrachloride. Accordingly, provided herein are methods which utilize a combination of both a first oxidant species that is a source of superoxide and a second oxidant species that is a source of hydroxyl radical for use in destroying DNAPLs, as well as compositions that are used to carry out the methods. At least one of the oxidizers, typically the first oxidizer that generates superoxide, is present in the formulations in a slow release form or matrix since superoxide is a short-lived agent. Provision of the first oxidizer in a stabilized, slow release form permits the effects of superoxide release to be sustained over are period of time. The second hydroxyl radical releasing oxidizer is inherently more stable and thus may be provided in any of several forms, including in solution, in a slow release matrix, or in some other convenient form. In some aspects, both oxidants are present in slow release matrices, either in the same matrix preparation, or in separate matrix preparations for mixing prior to use. When the combination is delivered to a site that is contaminated with DNAPLs e.g. in contaminated water, subsoil, etc., the oxidants, and/or the reactive species generated by them, remain active for many days or even weeks, providing superoxide and hydroxyl radical to both increase the rate of dissolution of the DNAPLs into the aqueous phase and break down DNAPLs dissolved in the aqueous phase. Thus, the long-acting formulations and methods of using the formulations are more effective and efficient than those which were previously known for ridding a site of DNAPL contamination via ISCO.

In one aspect, the stabilized, sustained release formulations described herein comprise stabilized, slow release percarbonate (PC) as a source of superoxide and stabilized, slow release persulfate (PS) as a source of hydroxyl radical. Activated sodium persulfate is known to generate hydroxyl radical. However, minimal superoxide is generated in activated persulfate systems. However, the dissolution of sodium percarbonate does generate superoxide. These and other reactivities of these species are summarized in Table 1.

TABLE 1
Summary of Reactivity of Sodium Percarbonate
and Activated Persulfate Systems

| | Transient | Enhanced | | |
|---|---|---|---|---|
| | Oxygen | Disruption/ | Degrades | Degrades |
| | Species | Dissolution of | Carbon | Perchloro- |
| Reactant | Generated | DNAPLs | Tetrachloride | ethylene |
| Sodium | Superoxide | Yes | Yes | No |
| Percarbonate | | | | |
| Activated | Hydroxyl | No | No | Yes |
| Persulfate | Radical | | | |

Generally, at least the first superoxide generating oxidizer is present in a stabilized, slow release form or matrix when used in the practice of the invention. “Slow release” refers to release of an agent over an extended, sustained, prolonged, controlled, etc. period of time. In the present case, it is desirable for the products generated by the oxidizers to be active for at least about one week, and preferably for at least about 10 days, and more preferably from e.g. at least about 30 days or even longer (e.g. for about 5 or 6 months). For example, a first oxidizer such as PC, when released into an aqueous environment, dissolves rapidly, generating superoxide that is highly reactive but dissipates rapidly. Thus, in some aspects, the formulations comprise stabilized or slow release PC as a first oxidizer that generates superoxide. For PC, slow release forms include crystalline forms that are resistant to rapid dissolution, as well as PC that is embedded in a solid slow release matrix as described herein. When embedded in a slow release matrix, the PC is generally in particulate form, and may be in the form of a powder, crystals, flakes, etc. dispersed throughout the matrix.

Numerous formulations are available as stabilizing, slow release matrices that can be used in the practice of the present invention. In some aspects, it is sufficient to crystallize an oxidizer to form stable, slow dissolving crystals. Alternatively, formulations are known in the art e.g. for time release fertilizers, pesticides, pharmaceuticals, etc. and these formulations can be adapted for use in the present. For example, a slow release matrix developed from attapulgite clay, ethyl cellulose, and sodium carboxymethylcellulose has been developed and may be used. Other slow release formulations include silicate polymers, paraffins, and crosslinked starch. In addition, Yao et al, 2013, Environ. Sci. Technol., 47 (15), 8700-8708; Ni et al., J. Agr. Food Chem., 59 (18), 10169-10175; Guo et al. 2006, J. Appl. Polym. Sci., 99 (6), 3230-3235; and Kitade et al. 1983, Journal of the Pharmaceutical Society of Japan, 103(7), 726-31, describe slow or time release formulations, as do issued U.S. Pat. Nos. 9,115,035; 9,090,495; 9,090,495; 9,161,943; 8,870,996; and 8,696,784 and published US patent applications 20150259261; 20150099751; 20140256695; and 20140017496. The entire contents of each of these references are hereby incorporated by reference in entirety.

The second hydroxyl radical generating oxidizer, due to its greater stability and ability to release hydroxyl radical over a sustained period of time comparable to slow release matrices, may or may not be provided for use in a slow release matrix. For example, if the second oxidizer is PS, is may be provided in solution that is mixed with e.g. a stabilized, slow release source of PC just before use. For example, the second oxidizer may be in solution in a liquid such as water, an alcohol, a buffered solution, a carbohydrate (e.g., lactate), or mixtures of these. Alternatively, the second oxidizer may be provided as a solid, e.g. as particles, which may or may not be formed from a matrix such as a slow release matrix. In some aspects, both the first and second oxidizers are provided in stabilized solid forms, e.g. in a single slow release matrix preparation in which the two are combined. In other aspects, the first and second oxidizers are provided in solid forms but in different preparations such that the first oxidizer is in a stabilized, slow release form, and the second oxidizer may or may not be in a stabilized, slow release form, but is a solid. In some aspects, the second oxidizer is PS, generally “activated” PS. By “activated PS” we mean that in a preparation, the PS is present together with an activator such as a base (e.g. an OH⁻ source such as sodium hydroxide, potassium hydroxide, calcium hydroxide, etc), or a metal [e.g. iron (H) sulfate, iron (II) chloride, iron (III)-ethylenediamine tetraacetic acid (EDTA), iron (III)-citrate], etc. Other activators that may be present include but are not limited to iron (0) (zero valent iron), activated carbon, phenols, glucose, low molecular weight ketones and keto acids (acetone, oxalate, pyruvate, succinate, a-keto glutarate, etc).

A solid preparation comprising a first oxidizer, or a second oxidizer, or a first and second oxidizer, is generally made up of or is formed into (e.g. by crushing, milling, etc.) a plurality of individual units which when used are in the form of e.g. particles, crystals, powders, flakes, etc. However, other forms are not excluded, e.g. balls, sheets, slabs, cylinders, shapes molded to fit a particular container, etc. In addition, a solid preparation may be coated onto the outside or inside of a solid support.

The first and second oxidant species, e.g. PC and PS, may be present in a preparation in any suitable amounts and proportions. The amounts of each generally range from about 1 to about 99% of the composition, by weight %, and are more usually in the range from about 25% to 40% for PC and about 60% to 75% for PS.

In addition, other active or inert agents may also be present in the formulations, including but not limited to: various fillers, buffering agents, agents that facilitate mixing, pH modifying agents, other agents which are active against DNAPLs or other contaminants, etc.

Exemplary first oxidant species include but are not limited to: PC, sodium perborate, and potassium superoxide. The first oxidant must slowly decompose (over several weeks-months into superoxide.

Exemplary second oxidant species include but are not limited to: PS, calcium peroxide, sodium peroxymonocarbonate, stabilized hydrogen peroxide, and organic peroxides (e.g., tert-butyl peroxide). The second oxidant must have a lifetime of several weeks-months and generate hydroxyl radical as it decomposes.

In some aspects, the amounts of active agents present in the formulations are tailored to particular sites in order to conveniently deliver a particular dose at a site of interest. For example, prior to deploying a device at a site, samples of contaminated soil and/or water from the area are analyzed and the amounts of active agents present in the formulations themselves are adjusted to achieve a desired dose upon deployment. Alternatively, preformed formulations containing standardized amounts of active agents may be made available and the amount of a standardized preparation to use may be calculated based on an analysis of the clean-up site.

The formulations can be delivered to any type of contaminated site, including but not limited to contamination present in trace (e.g., μg/L concentrations), at residual saturation, or in confined “pools”, as smear zones and ganglia, or that has diffused into soil or bedrock, etc.

When used in the methods described herein, the first and second oxidizers are delivered together, or substantially together, to an area of DNAPL contamination, so that both are active in releasing e.g. superoxide and hydroxyl at the same time, or at least at overlapping times, at the site. Regardless of the particular form of the first and second oxidizers, if they are not already together in a single preparation, then they are generally mixed together prior to use, i.e. prior to the time of contact with a site contaminated with DNAPLs. For example, if the two oxidizers are embedded in a single matrix preparation, the matrix will generally be in particulate form, and prior to use, the particles are combined with a liquid carrier such as water to form a “slurry”. The slurry is of a viscosity that allows it to be pumped through conventional pumps and flow through e.g. a shaft that penetrates into the area that is being treated. Alternatively, if the first and second oxidizers are present in different matrix preparations and/or in different phases, the two are still combined into a mixture with a liquid carrier to form a slurry for delivery. Alternatively, the first and second oxidizers may be delivered to a site separately (e.g. in separate slurries), with one being delivered immediately after the other.

In alternative aspects, the first and second oxidizers are in a solid form and are delivered as a solid. For example, a solid particulate preparation of the two oxidizers can be housed in a water permeable container (e.g. mesh or wire “cage”, a fabric bag, etc.) that is placed, e.g. in a contaminated body of water. Water enters the container and dissolves the oxidizers, which then generate the reactive species in situ.

In exemplary aspects, typical dosages of sodium persulfate that are used at a site range from about 2 to about 10 g/kg of soil being treated, or about 0.5% to about 2.5% when delivered to groundwater. Target percarbonate dosages in the groundwater at a site typically range from about 1% to about 5%. However, the precise conditions for ISCO are generally site specific and determined on a site-by-site basis. This typically involves conducting an initial laboratory treatability study of a site that is identified as a possible contaminated site. The results of the study are used to design a system to deliver a suitable quantity of reagents to a suitable location at the site. Treatability studies are established using contaminated soils and/or groundwater from the site. After samples are received by the laboratory, they are kept under refrigeration and characterized for e.g. contaminant concentration, pH, oxidation-reduction potential, and dissolved oxygen. The soil is mixed so that the contamination is homogeneous in the entire sample. Separate soil aliquots (e.g., 50 g each) are then weighed into several reactors (e.g., 40 mL volatile organic analysis vials or 100 mL wide mouth glass jars). A matrix of different concentrations of the stabilized percarbonate-sodium persulfate formulation is then added to groundwater from the site. The groundwater containing the different concentrations of the formulation is then added to each of the vials containing the soil. The typical groundwater:soil ratio is that sufficient to cover the soil plus a small extra volume (e.g., 2 mL) to subsequently sample for hydrogen peroxide, persulfate, and pH. The reactors are capped to prevent contaminant volatilization. An exemplary factorial design for such a treatability study is shown in Table 2.

TABLE 2
Example of solid sodium percarbonate and sodium persulfate
conditions that could be used in a DNAPL treatability study

| | Solid Percarbonate (PC) Concentrations (%) | | | | |
|---|---|---|---|---|---|
| Sodium | 1% PC/ | 2% PC/ | 3% PC/ | 4% PC/ | 5% PC/ |
| Persulfate | 0.5% PS | 0.5% PS | 0.5% PS | 0.5% PS | 0.5% PS |
| (PS) | 1% PC/ | 2% PC/ | 3% PC/ | 4% PC/ | 5% PC/ |
| Concentra- | 1% PS | 1% PS | 1% PS | 1% PS | 1% PS |
| tions (%) | 1% PC/ | 2% PC/ | 3% PC/ | 4% PC/ | 5% PC/ |
| | 1.5% PS | 1.5% PS | 1.5% PS | 1.5% PS | 1.5% PS |
| | 1% PC/ | 2% PC/ | 3% PC/ | 4% PC/ | 5% PC/ |
| | 2% PS | 2% PS | 2% PS | 2% PS | 2% PS |
| | 1% PC/ | 2% PC/ | 3% PC/ | 4% PC/ | 5% PC/ |
| | 2.5% PS | 2.5% PS | 2.5% PS | 2.5% PS | 2.5% PS |

At selected time points (e.g., a few days, a week, two weeks, four weeks, six weeks, eight weeks, etc.) a set of reactors are analyzed for pH, persulfate concentration, hydrogen peroxide concentration, and contaminant concentration.

After the data for the treatability study have been collected and the results analyzed, the optimum conditions for decontamination are determined. The optimal conditions would include those which result in maximum first and second oxidant longevity and maximum contaminant/DNAPL destruction. For example, in exemplary aspects, a suitable level of DNAPL destruction in a sample will be at least about 75%, and preferably at least about 80, 85, 90, 95 or more % destruction. Samples with these levels of DNAPL elimination are selected as having had optimal reaction conditions. The conditions selected for use at a site will generally also take into account the amount of first and second oxidant that remains. Reactors in which the least amounts of active agents are left over and yet which have an acceptable level of DNAPL destruction are selected as optimal. For example, referring to Table 1 above, if 2.0% PC and 1.5% PS are sufficient to achieve 95% DNAPL destruction with less than about 30% or less (e.g. about 25, 20, 15, 10, or 5%) of each reactant remaining, there will generally be no need to use higher concentrations of the active agents at the site. In another example, the optimum conditions after six weeks of bench scale treatment might be 1) sodium percarbonate remaining=15%, 2) sodium persulfate remaining=30%, and 3) NAPL destruction=90%. These conditions could then be used for application of the formulation at the contaminated site.

Contaminants that are eliminated at sites as described herein are generally DNAPLs. By “DNAPL” we mean a liquid that is both denser than water and is immiscible in or does not dissolve significantly in water (e.g. dissolution of DNAPLs ranges from about 0.1 μg/L to about 50 mg/L). The water solubility of DNAPL compounds can reach approximately 10% of their theoretical water solubility, which for most is no higher than 500 mg/L. Therefore, the maximum dissolution is about 50 mg/L. When disposed of improperly or spilled inadvertently (or purposefully) they can contaminate groundwater, surface water and/or sediments. Because of their chemical properties, DNAPLs tend to sink below the water table in significant quantities when spilled and only stop when they reach impermeable bedrock. Their ability to penetrate into aquifers makes them difficult to locate and remediate.

DNAPLs that can be destroyed using the compositions and methods described herein include but are not limited to: chlorinated solvents, such as trichloroethylene, perchloroethylene, 1,1,1-trichloroethane, 1,1,2-trichloroethane, chloroform, methylene chloride, 1,2-dichloroethane, 1,2-dichloropropane, and carbon tetrachloride; coal tar; creosote; polychlorinated biphenyls (PCBs); chlorobenzenes (e.g., chlorobenzene, 1,2-dichlorobenzene, 1,3-dichlorobenzene, 1,4-dichlorbenzene, etc), chlorophenols (e.g., 2-chlorophenol, etc.), chloroanilines (e.g., 2-chloroaniline, etc), hexachlorocyclopentadiene, extra heavy crude oil with an American Petroleum Institute (API) gravity of less than 10, and the like.

Implementation in the field. Several options exist for delivery of the stabilized formulations into the subsurface. The most common delivery systems are 1) direct push, and 2) permanent injection wells. Direct push systems include perforated rods that are hydraulically driven into the subsurface. The rods are connected to a pump linked to a feed tank containing the stabilized formulation, which would generally consist of a slurry of stabilized crystals of sodium percarbonate and dissolved sodium persulfate or stabilized crystals of sodium persulfate. As used herein, “slurry” refers to a semiliquid mixture, typically comprising fine particles of a solid. After the formulation is delivered, the rod is removed from the soil and the procedure is repeated close to (e.g. 0.5 m-1 m away) from the first injection site. This procedure is typically carried out at least once or twice, and may be performed e.g. 3-5 times or more, depending on the extent of the contamination. The injection events are usually carried out 6-12 weeks apart.

Alternatively, permanent injection wells are placed into the ground using a boring rig, which is often mounted on a large truck. After a borehole is dug, a permeable well casing is inserted and the space around the casing is filled with gravel. A concrete cap is then placed over the wellhead through which a valved piping is attached that is connected to a high pressure pump and a percarbonate-persulfate feed tank. Similar to direct push systems, the feed tank would typically contain a slurry of stabilized crystals of sodium percarbonate and dissolved sodium persulfate or stabilized crystals of sodium persulfate.

Although permanent wells cost more than direct push injections, the cost of the two systems is often nearly equal for most projects. An ISCO clean up usually requires three rounds of injections, and the cost of three sets of direct push injections is about the same cost of placing permanent injection wells. However, the slow release formulations described herein may decrease the number of injection rounds that are required, thereby reducing the cost of cleaning a site.

Other less-used methods of oxidant delivery include soil mixing and hydraulic fracturing. Soil mixing is used in shallow-to-intermediate zones and is carried out with standard construction equipment, such as bucket mixers. Alternatively, specialized proprietary blade systems have been developed to mix ISCO reagents into the subsurface.

Hydraulic fracturing involves creating fractures in soils of low permeability. The fractures are generated by first drilling a borehole into the subsurface followed by forcing a jet of water into the hole to create fractures. The oxidant formulations are then injected into the fractures.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference, and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1

### An Innovative Peroxygen System in the In Situ Chemical Oxidation (ISCO) Destruction of Dense Nonaqueous Phase Liquids (DNAPLs)

Contamination of soil and groundwater by nonaqueous phase liquids (NAPLs) from industrial and waste disposal activities is a serious concern. Chlorinated aliphatic hydrocarbons (CAHs) are dense nonaqueous phase liquids (DNAPLs), which are present at 80% of Superfund sites and over 3000 Department of Defense (DoD) sites in the U.S. Furthermore, there is a high likelihood of DNAPLs presence in 60% of the contaminated sites on the National Priorities List (NPL). Compared to light nonaqueous phase liquids (LNAPLs), DNAPL remediation is significantly more difficult in the subsoil due to its tendency to move downward because of gravity and capillary forces in the pore spaces. These DNAPLs then serve as continuous sources of contaminants to groundwater because of their presence as large pools, ganglia, globules, and smear zones in the subsurface.

In situ chemical oxidation (ISCO) has received considerable attention over the past two decades as a means to destroy DNAPLs. Several reagents have been examined as ISCO oxidants; these include ozone, permanganate, hydrogen peroxide and activated persulfate.

With respect to persulfate, the major advantage is its longevity in the subsurface and production of several reactive oxidant species after activation. A wide range of activators have been investigated to date including heat, transitional metals, base, minerals, phenoxide and quinones.

Persulfate is activated by base through the base catalyzed hydrolysis of persulfate (Furman et al. 2010; Ahmad et al., 2013).

—O₃S—O—O—SO₃—+H₂O+OH⁻→2SO₃²⁻+HO₂⁻+H⁺

—O₃S—O—O—SO₃—+HO₂⁻→SO₄²⁻+SO₄.⁻+O₂.⁻+H⁺

In both metal and base activated persulfate systems hydroxyl radical is generated by the reaction of sulfate radical with water and hydroxide (Hayon et al., 1972).

SO₄.⁻+H₂O→HSO₄⁻+OH.

SO₄.⁻+OH⁻→SO₄²⁻+OH.

The sulfate radical is an electrophile, perhydroxyl radical is a weak oxidant, superoxide is a weak reductant and nucleophile, and hydroperoxide anion is a strong nucleophile with wide reactivity (Watts and Teel, 2005; Neta et al., 1977).

Sodium percarbonate (Na₂CO₃.1.5H₂O₂), which is an inexpensive green oxidant, is an anhydrous source of hydrogen peroxide (Bjorsvik et al., 2004; Wada and Koga, 2013). The loose bond between H₂O₂ and Na₂CO₃ creates a flux of H₂O₂ in aqueous solution. Therefore the chemistry of SPC in the aqueous solution is similar to that of H₂O₂ chemistry. The alkaline pH of Na₂CO₃.1.5H₂O₂ promotes the decomposition of H₂O₂ into hydroperoxide anion in aqueous phase (Mckillop and Sanderson, 1995).

H₂O₂ [symbol] HO₂⁻+H⁺; pKa=11.

Another pathway of sodium percarbonate (SPC) in aqueous solution is its decomposition into peroxymonocarbonate anion (HCO₄⁻); widely known for its high reactivity (Lin and Liu, 2008). The homolysis of the O—O bond then starts a series of reactions producing hydroxyl radical (OH.), carbonate radical (CO₃.⁻), perhydroxyl radical (HO₂.), and superoxide radical anion (O₂.⁻) (Lin and Liu, 2009; Merker et al., 2012).

HCO₄⁻→CO₃.⁻+OH.

CO₃.⁻+H₂O₂→HCO₃⁻+HO₂.

HO₂.→O₂.⁻+H⁺

However, the very short lived (minutes to hours) nature of H₂O₂ in complex soil systems limits the efficacy of catalyzed H₂O₂ propagations (CHP, i.e., modified Fenton's reagent) systems in some soils.

The present example demonstrates the destruction of carbon tetrachloride and perchloroethylene DNAPLs with sodium percarbonate and combined sodium percarbonate-base activated sodium persulfate systems in simulated groundwater environments and in a natural soil environment. In particular, the efficacy of a slow-release formulation, which e.g. increased the lifetime of H₂O₂ in soil, was shown.

### Materials

The soil used was collected from an alluvial fan above the Carson Valley, Nev. The pipette method (Gee and Bauder, 1986) was used to determine particle size distribution. Organic carbon was determined by heating soil at 900° C. and trapping the CO₂ in potassium hydroxide (KOH) and subsequent titration of unreacted KOH (Nelson and Sommers, 1982). Cation exchange capacity was determined by saturation at pH 8.2 with sodium acetate (SCS, 1986). Citrate-bicarbonate-dithionite extraction and hydroxylamine hydrochloride extraction were used to determine crystalline and amorphous iron and manganese oxyhydroxides (Jackson et al., 1986). Characteristics of the Carson Valley soil are shown in Table 3.

TABLE 3
Characteristics of Carson Valley soil.

| Texture | Gravelly loam, coarse sand |
|---|---|
| Organic C content (mg/kg) | 16000 |
| Sand (%) | 86.1 |
| Silt (%) | 10.8 |
| Clay (%) | 3.1 |
| Crystalline Fe Oxides (mg/kg) | 4300 |
| Crystalline Mn Oxides (mg/kg) | 100 |
| Amorphous Fe Oxides (mg/kg) | 4000 |
| Amorphous Mn Oxides (mg/kg) | 100 |
| Cation exchange capacity (cmol(+)/kg) | 4.9 |
| pH | 6.6 |

Carbon tetrachloride (99.9%), perchloroethylene (99.9%), decane (>99%), sodium percarbonate, sodium persulfate (≧98%), sodium carbonate (anhydrous≧99%), and ammonium molybdate were purchased from Sigma Aldrich (St. Louis, Mo.). Sodium hydroxide (>99%) was obtained from VWR (West Chester, Pa.). Sodium bicarbonate (100%), potato starch, manganese dioxide (MnO₂), and sulfuric acid (98%) were obtained from J. T. Baker (Phillipsburg, N.J.). Potassium iodide (99%) was purchased from Alfa Aesar (Ward Hill, Mass.). ORBO® 32 gas adsorbent tubes were purchased from Supelco (St. Louis, Mo.). Double deionized water was purified to >18.0 MΩ cm using a Barnstead E-pure systems.

Oxiclean™ is a popular laundry detergent containing 34.1% sodium carbonate and 65.9% sodium percarbonate (Bracken and Tietz, 2005). It is available as slow release Oxiclean™ detergent ball which dissolves slowly in water and yields H₂O₂ with time. Thus an Oxiclean™ detergent ball can be a good source of slow release H₂O₂. Oxiclean™ slow release detergent balls were obtained from Church & Dwight, Ewing, N.J.

### Experimental Systems

### DNAPL—Percarbonate Systems

All reactions investigating the destruction of DNAPL by sodium percarbonate in deionized water systems were conducted in 40 mL borosilicate vials capped with a PTFE-lined septa. A Teflon tube, 4 mm in diameter, was inserted through the PTFE-lined septa, and connected to an ORBO-32 gas adsorbent tube to trap the volatile fraction of the contaminants. Each of the reaction vials had a 10 ml aqueous layer containing the reactants (3.14 g sodium percarbonate in 10 ml deionized water=2 M solution) and a 5 mmol DNAPL. The reaction systems were set up in triplicate: Reaction, control, and gas-purge. The pH of the control system was maintained at 10.5 to facilitate the same ionic strength in control and reaction vials.

### DNAPL-Percarbonate-Activated Persulfate Systems

In these reaction systems, five different combinations of sodium percarbonate and base activated persulfate were used to enhance the degradation of DNAPLs:
System 1: 5 mmol DNAPL+2 M sodium percarbonate+0.1 M sodium persulfate+0.2 M NaOH
System 2: 5 mmol DNAPL+2 M sodium percarbonate+0.2 M sodium persulfate+0.4 M NaOH
System 3: 5 mmol DNAPL+2 M sodium percarbonate+0.3 M sodium persulfate+0.6 M NaOH
System 4: 5 mmol DNAPL+2 M sodium percarbonate+0.4 M sodium persulfate+0.8 M NaOH
System 5: 5 mmol DNAPL+2 M sodium percarbonate+0.5 M sodium persulfate+1.0 M NaOH

All the reactions were conducted in closed 40 mL borosilicate vials capped with PTFE-lined septa. The aqueous layer was 10 ml and DNAPL used was 5 mmol.

DNAPL-Soil-Percarbonate Systems The reactions were conducted in closed 40 mL borosilicate vials capped with

PTFE-lined septa. Similar to the DNAPL-percarbonate system, a gas sampling port was used to quantify volatilization losses by trapping volatilized DNAPLs in ORBO-32 gas adsorbent tubes. 10 ml aqueous layer with 5 mmol of DNAPL was used with 10 g soil to quantify DNAPL mass destruction in a complex soil system. The Carson Valley soil with and without soil organic matter (SOM) was used. Raw soil was heated at 400° C. for 16 hours to remove the SOM. The two percarbonate systems studied were defined as:
System 1: 5 mmol DNAPL+2 M sodium percarbonate+10 g soil with SOM
System 2: 5 mmol DNAPL+2 M sodium percarbonate+10 g soil without SUM

### DNAPL-Soil-Stabilized Percarbonate-Persulfate Systems

In these reaction systems, three different combinations of Oxiclean™ and persulfate were used to enhance the degradation of DNAPLs in a complex soil environment:
System 1: 5 mmol DNAPL+4.76 g Oxiclean™+0.2 M sodium persulfate+10 g soil
System 2: 5 mmol DNAPL+4.76 g Oxiclean™+0.4 M sodium persulfate+10 g soil
System 3: 5 mmol DNAPL+4.76 g Oxiclean™+0.6 M sodium persulfate+10 g soil

The reactions were conducted in closed 40 mL borosilicate vials capped with PTFE-lined septa. 10 ml aqueous layer, 4.76 g fine grained Oxiclean™ with 5 mmol DNAPL, and 10 g soil with SOM were used in these systems. Because Oxiclean™ contains 65.9% sodium percarbonate, 4.76 g Oxiclean™ is equivalent to 3.14 g sodium percarbonate (Bracken and Tietz, 2005).

### Gas Purge Dissolution

To determine the maximum rate of gas purge dissolution (Brusseau et al., 1990) of the DNAPLs, pure air was supplied through a 4 mm diameter Teflon tube connected with a diffuser stone at 200 mLmin⁻¹ to vials containing 10 mL of 2 M sodium carbonate solution, and 5 mmol of DNAPL. The escaping contaminants were trapped using ORBO® 32 gas adsorbent tubes.

### Extraction and Analysis

In the DNAPL-percarbonate systems, triplicate reactors and ORBO® 32 tubes were sacrificed at each time point and the DNAPL and aqueous phases were separated for analysis with a Pasteur pipette. The DNAPL and aqueous phases were then shake-extracted with 10 ml decane for 30 minutes. The ORBO® 32 tubes were also extracted with 5 ml decane for 30 minutes. A Hewlett-Packard 5890A gas chromatograph with a 0.53 mm (i.d.)×60 m Equity® 1 capillary column and flame ionization detector (FID) were used to analyze the extracts. The initial temperature was 60° C., the final temperature was 260° C., the injector temperature was 260° C., the detector temperature was 280° C., and the program rate was 50° C. min⁻¹. Both hydrogen peroxide and persulfate concentrations were measured by iodometric titration using 0.1 N and 0.01 N sodium thiosulfate, respectively (Kolthoff & Stenger, 1947). A Fisher Accumet™ AB15 pH meter was used to measure the pH in the vials. The results from the three replicate vials were averaged and error bars were used to represent the standard error of the mean.

In the DNAPL-soil-percarbonate systems, the entire reactors were extracted with 10 ml decane and ORBO® 32 tubes were extracted with 5 ml decane for 30 minutes. In the DNAPL-percarbonate-activated persulfate and DNAPL-soil-stabilized percarbonate-persulfate systems, the whole vials were extracted with 10 ml decane for 30 minutes.

### Results and Discussion

### DNAPL-Percarbonate Systems

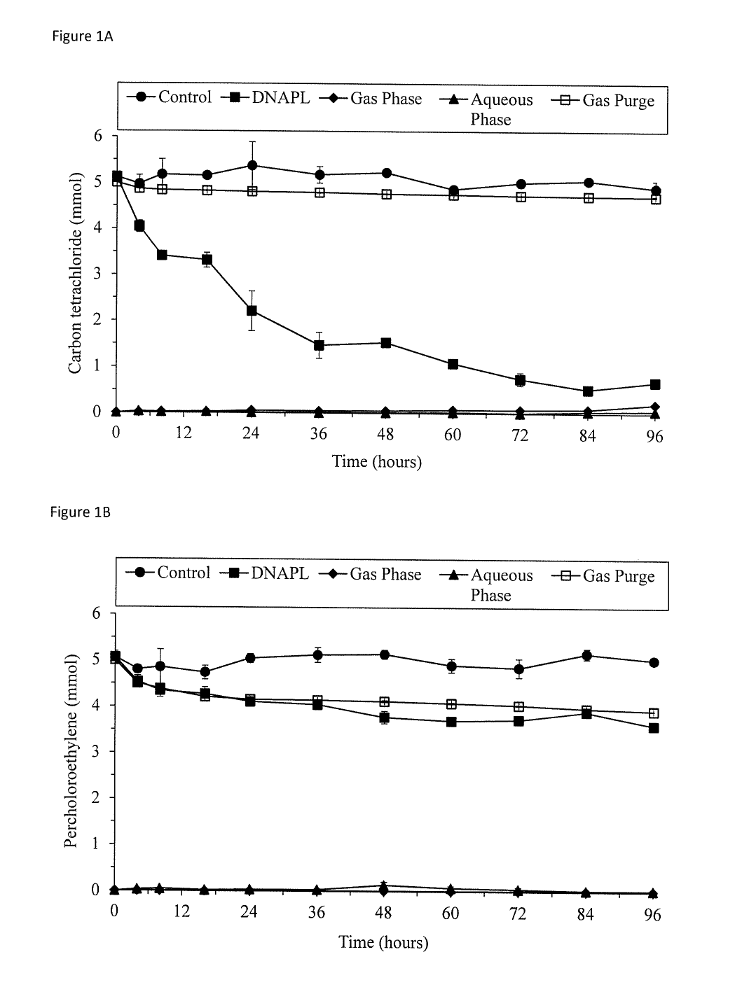

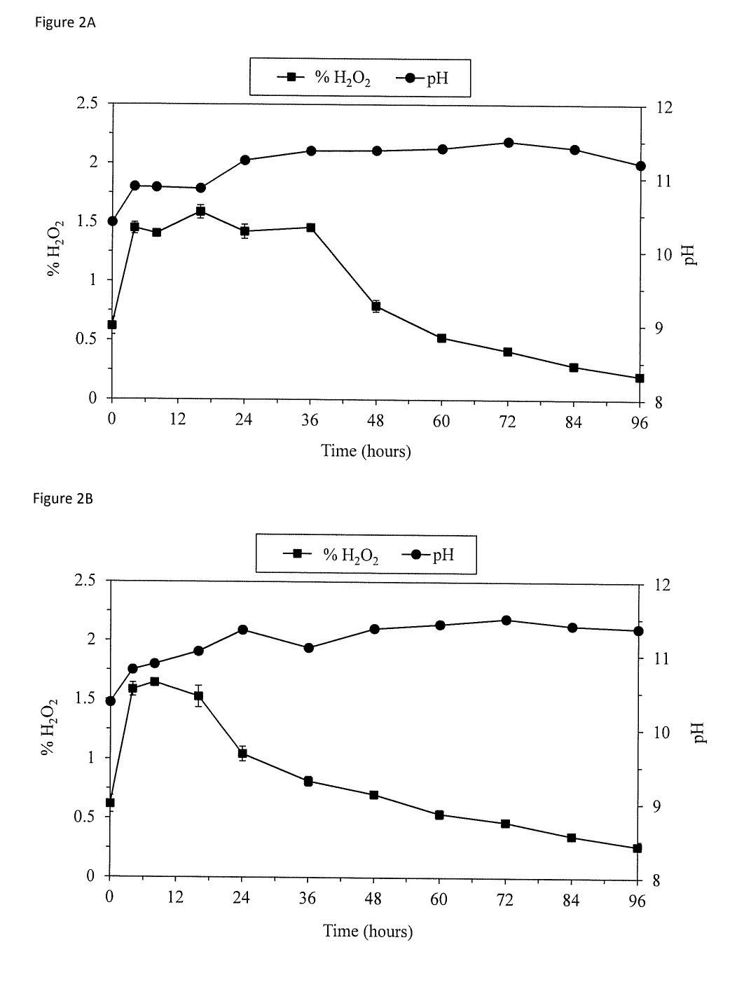

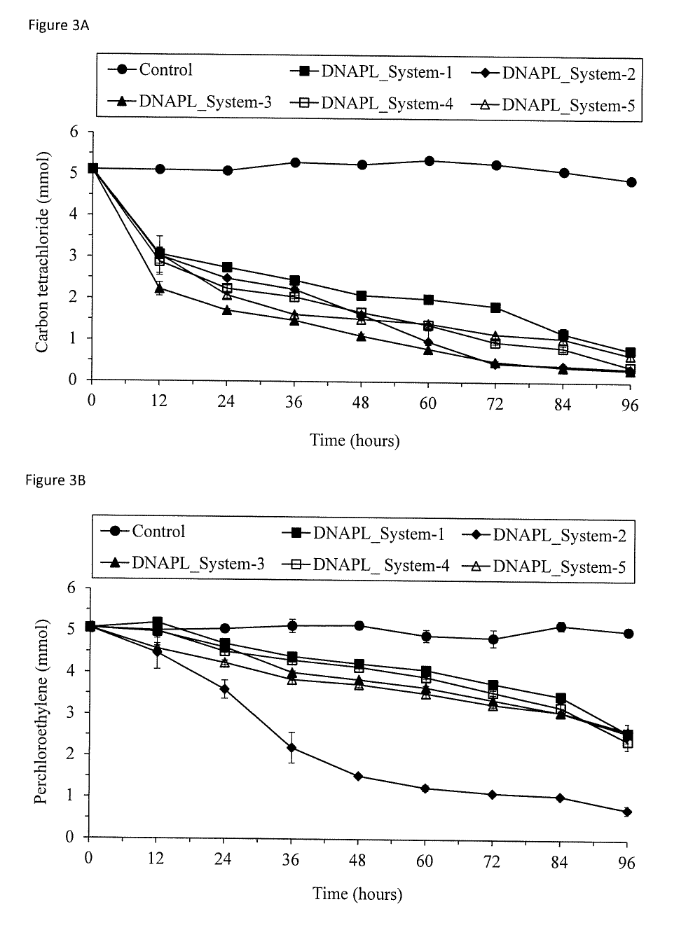

Destruction of the carbon tetrachloride (CT), and the perchloroethylene (PCE) DNAPL in the sodium percarbonate system is shown in FIGS. 1A and 1B. Approximately 86% the CT DNAPL mass was destroyed and the loss of the PCE DNAPL was 28% over 96 hours. After subtracting the mass loss in gas phase (captured in the ORBO® tube), and aqueous phase, the net loss of CT was 81% and PCE was 27.5% over 96 hours. In the parallel control system, containing deionized water, no measurable DNAPL mass was lost over the same time period. In the parallel gas purge system, containing deionized water of the same ionic strength as the reaction vials, only 5.9% CT and 21.5% PCE mass was lost through dissolution over 96 hours (FIGS. 3A and 3B). Both CT and PCE were destroyed at a rate greater than the rate of gas purge dissolution, which represents the maximum rate of dissolution because the residual concentration in the water is negligible. The concentration of H₂O₂ and its stability in the CT system is higher than in the PCE system (FIGS. 2A and 2B). Both the systems had the same pH range (10.5-11.5), which increased with time (FIGS. 2A and 2B).

Smith et al. (2006, 2009) investigated the destruction of chlorinated solvents with CHP systems. They concluded that only superoxide radical is responsible for the enhanced rate of dissolution and destruction of CT and PCE DNAPLs. CT is nonreactive with hydroxyl radical (KOH.<2×106 M-1S-1) but PCE is reactive with hydroxyl radical (KOH.=2.8×109 M-1S-1) (Haag and Yoo, 1992; Buxton et al., 1988). However hydroxyl radical is short lived in nature in aqueous systems and does not permeate DNAPLs (Sheldon and Kochi, 1981). Therefore, without being bound by theory, it appears that the destruction of CT and PCE DNAPL mass in the percarbonate systems was mainly due to the reactivity of superoxide radical with the DNAPLs.

### DNAPL-Percarbonate-Activated Persulfate Systems

Five percarbonate-activated persulfate systems were evaluated for destruction of the CT and PCE DNAPLs. Systems 2 and 3 worked significantly better than the percarbonate system with CT destruction of 93.5%, 94% respectively over 96 hours. Alternatively, the CT mass loss in Systems 1, 4, and 5 was 84.5%, 92.5%, and 87% respectively over the same time period. In the parallel control system, mass loss was 2.2% (FIG. 3A).

The degradation of PCE by these five systems showed more effective treatment than the PCE-percarbonate system. Among the five systems, System 2 showed approximately 85.5% PCE degradation over 96 hours, which is approximately three times the rate of destruction compared to the destruction in PCE-percarbonate system. The other 4 Systems showed around 50% degradation of PCE over the same time period. There was no significant loss of PCE mass in the parallel control vials (FIG. 3B).

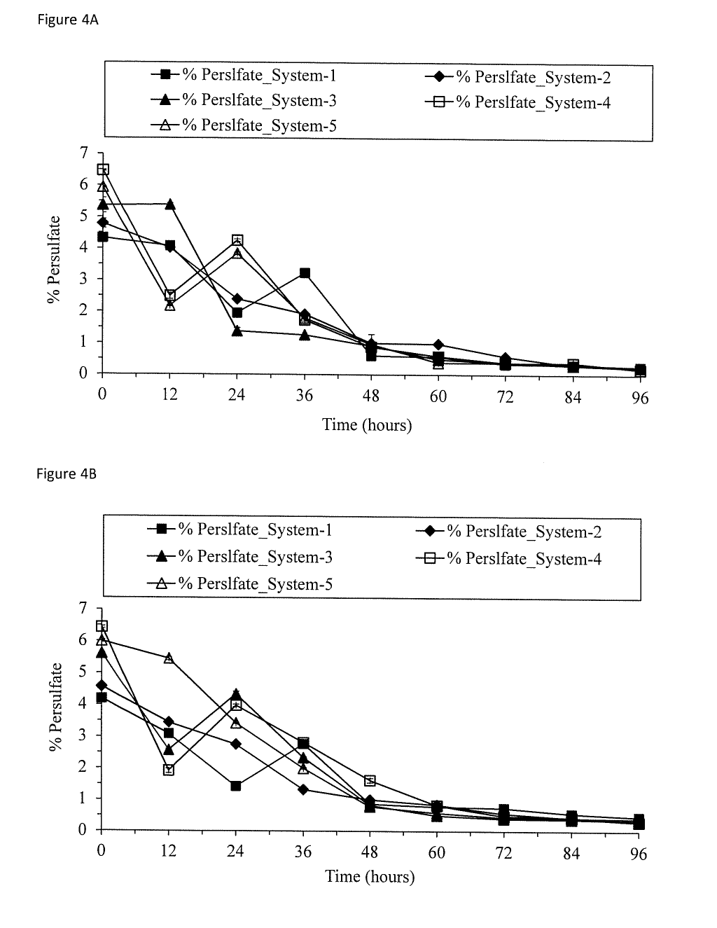

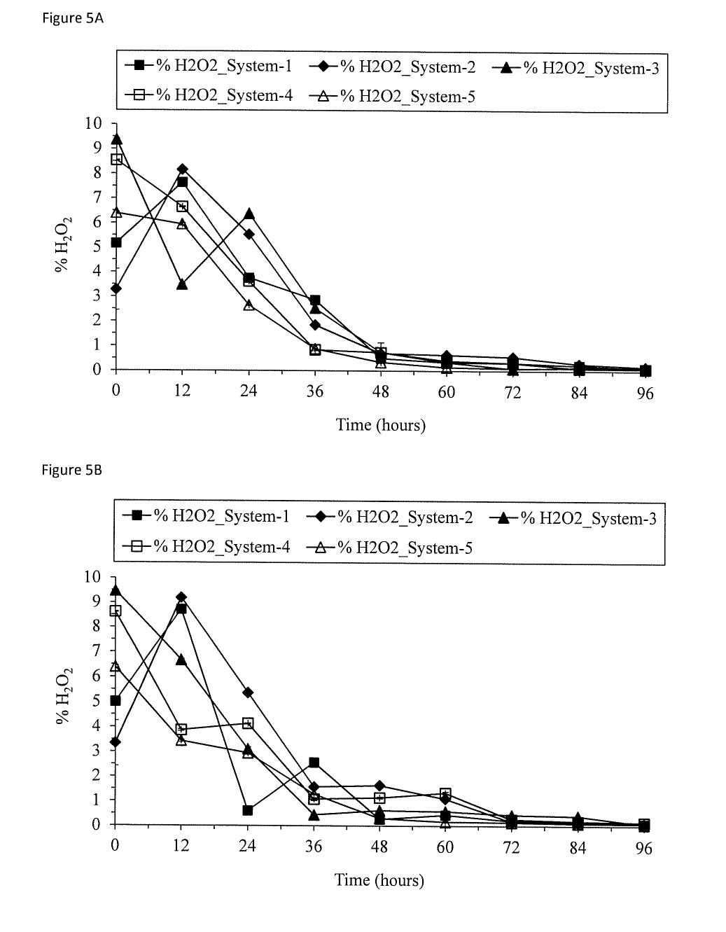

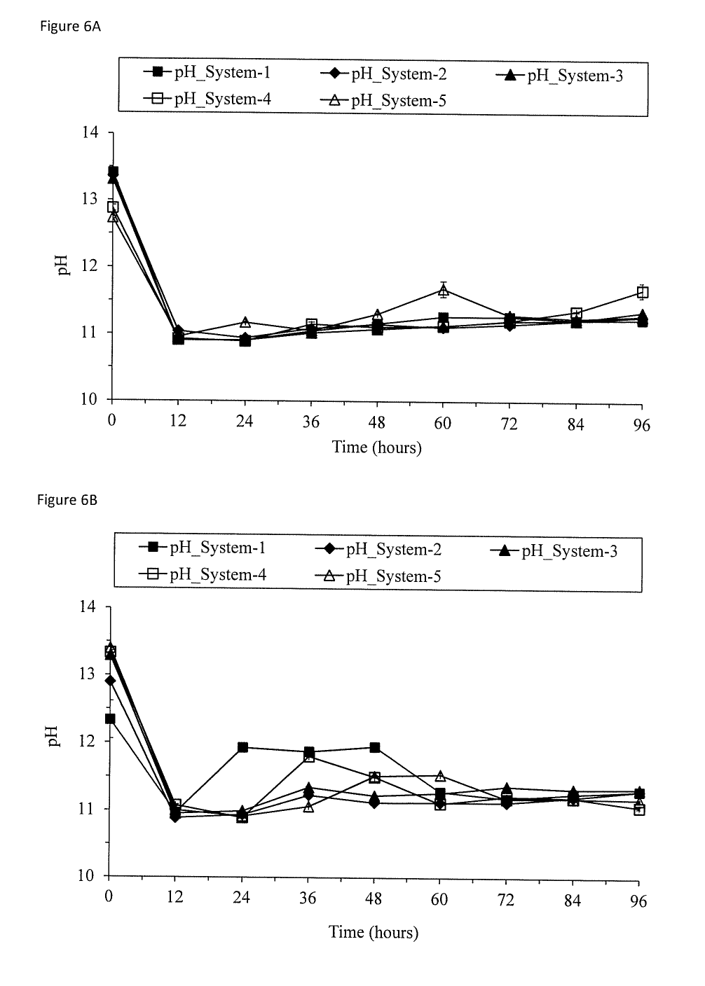

The better destruction of the CT DNAPL in Systems 2 and 3 may be due to the higher residual concentration of % H₂O₂ in the systems (FIG. 5A). The residual persulfate concentration in Systems 3, 4, and 5 were higher than in the other systems initially but the persulfate concentration in these systems decreased with time similar to the H₂O₂ concentrations (FIG. 4A). The pH of these systems reached the range of 11-11.3 after 36 hours (FIG. 6A). Similar to the CT systems, H₂O₂ and persulfate residual in the PCE systems followed the same decreasing trend (FIGS. 4B and 5B). The pH of the systems reached the range of 11.1-11.3 after 60 hours (FIG. 6B).

Since activated persulfate systems do not produce a significant flux of superoxide radical compared to CHP systems, the combination of percarbonate and activated persulfate may produce more superoxide compared to a percarbonate only system. Without being bound by theory, this increased flux of superoxide may be responsible for the enhanced destruction of CT and PCE in the combined percarbonate-activated persufate systems. The generation of sulfate radical (SO₄²⁻.) from the activated persulfate systems might have an insignificant effect on the destruction of CT and PCE since sulfate radical is an electrophile and is nonreactive with compounds having electron withdrawing groups.

### DNAPL-Soil-Percarbonate Systems

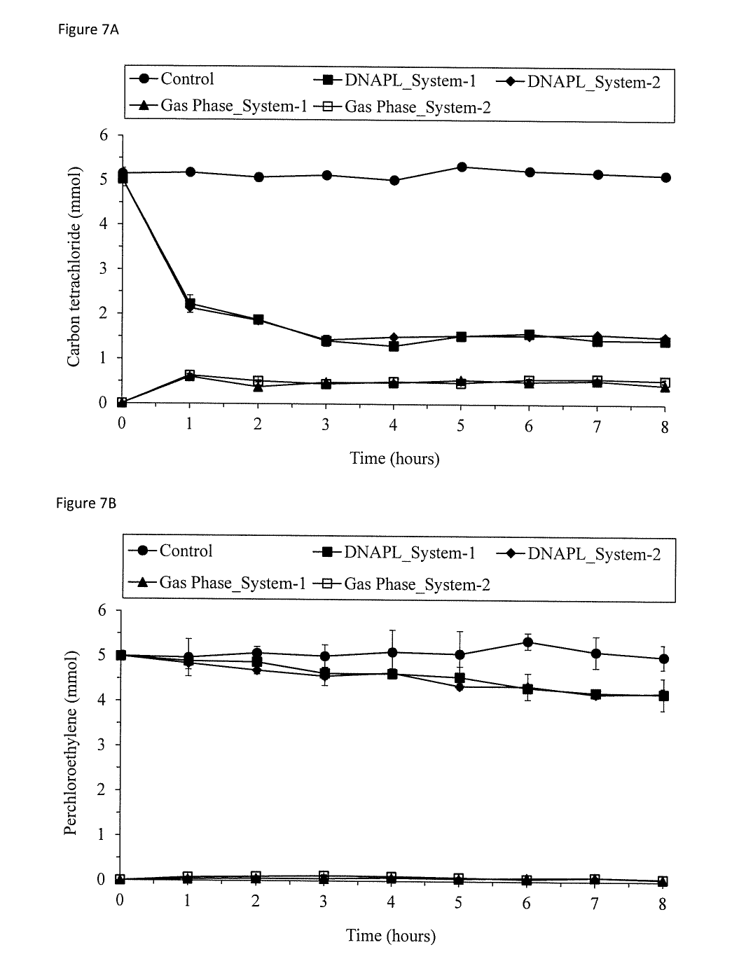

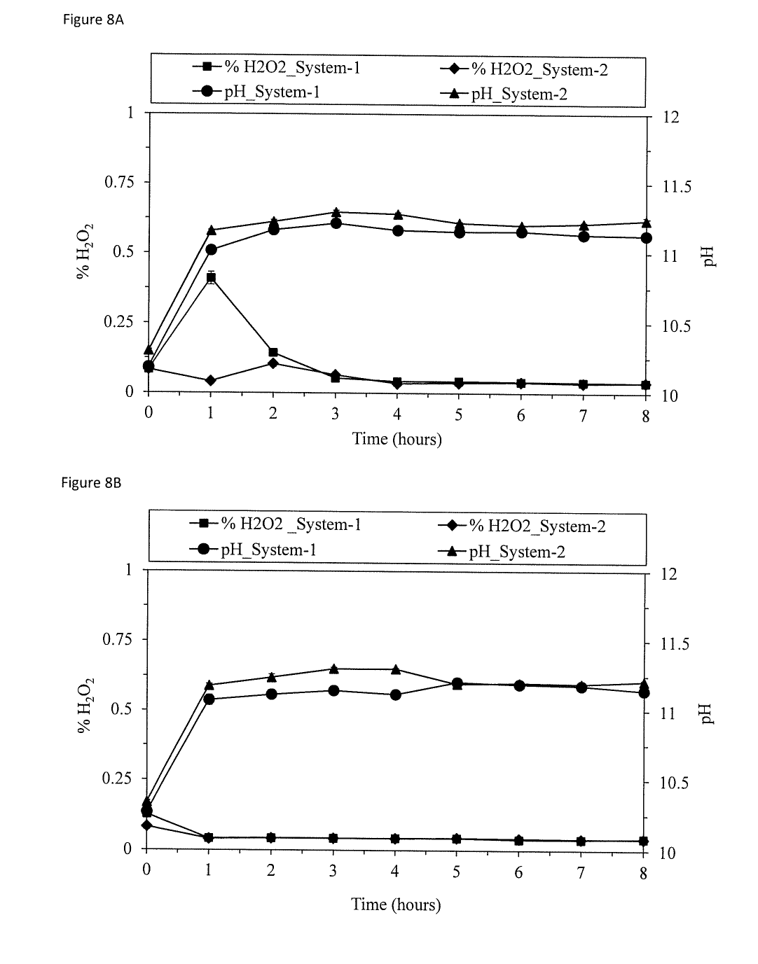

A similar CT destruction pattern was found for both System 1 (soil with SOM) and System 2 (soil without SOM) over a period of 8 hours with approximately 71% and 70% destruction of CT DNAPL mass in Systems 1 and 2 (FIG. 7A). Considering the DNAPL mass captured in the ORBO™ tube (gas phase) (8.7% and 10.7% in Systems 1 and 2 respectively), the net loss of CT mass in the soil-percarbonate systems over 8 hours was 62.3% and 59.3%. Therefore, the soil organic matter had minimal effect on the degradation of CT DNAPL in the natural soil environment (FIG. 7A). Hydrogen peroxide decomposition in the natural soil systems was rapid with only 3 hours before the H₂O₂ decomposed to non-detectable concentrations (<0.1%). The pH in the systems was in the range of 11.0 -11.3 (FIG. 8A).

The destruction pattern of PCE was similar to the CT systems, but the destruction was significantly lower. Only 16.3% and 16.1% of the PCE mass was destroyed in System 1 (soil with SOM) and System 2 (soil without SOM) respectively (FIG. 7B). Considering the mass loss in the gas phase (0.9% and 1.1%, respectively, in two systems), the net PCE mass losses were 15.4% and 15%, respectively. SOM had the same insignificant effect on PCE mass destruction (FIG. 7B). The lifetime of hydrogen peroxide in both systems was too short for field applications and very similar to that of the CT systems. The pH of the systems ranged from 11.0-11.3 (FIG. 8B).

Without being bound by theory, it is likely that the ineffective treatment of DNAPLs in the soil-percarbonate systems is due to the short lifetime of H₂O₂. The rate of destruction of CT DNAPLs was negligible after 3 hours (FIG. 7A) due to the minimal concentration of H₂O₂. In the PCE-soil-percarbonate system the destruction rate became negligible at 8 hour because the hydrogen peroxide was depleted (FIG. 7B).

### DNAPL-Soil-Stabilized Percarbonate-Persulfate Systems

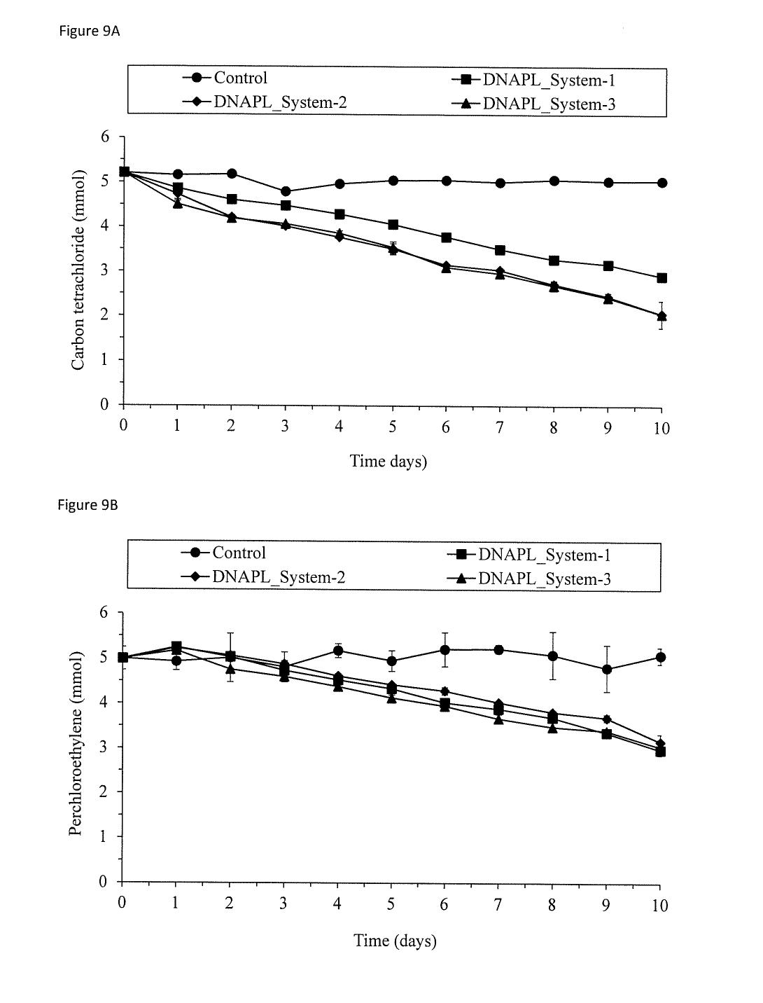

The degradation of the CT and PCE DNAPLs improved significantly with slow release percarbonate (as a source of hydrogen peroxide) and sodium persulfate in the presence of the Carson Valley soil. CT DNAPL destruction was 44.5% in System 1 and 60.5% in Systems 2 and 3 over 10 days (FIG. 9A). DNAPL loss was negligible in parallel control reactors. PCE DNAPL mass loss was 40.5%, 37.0%, and 39.0% in Systems 1, 2 and 3, respectively, over the same time period of 10 days (FIG. 9B). The destruction of the PCE DNAPL was significantly greater when compared to PCE-percarbonate (FIG. 1B) and PCE-soil-percarbonate systems (FIG. 7B).

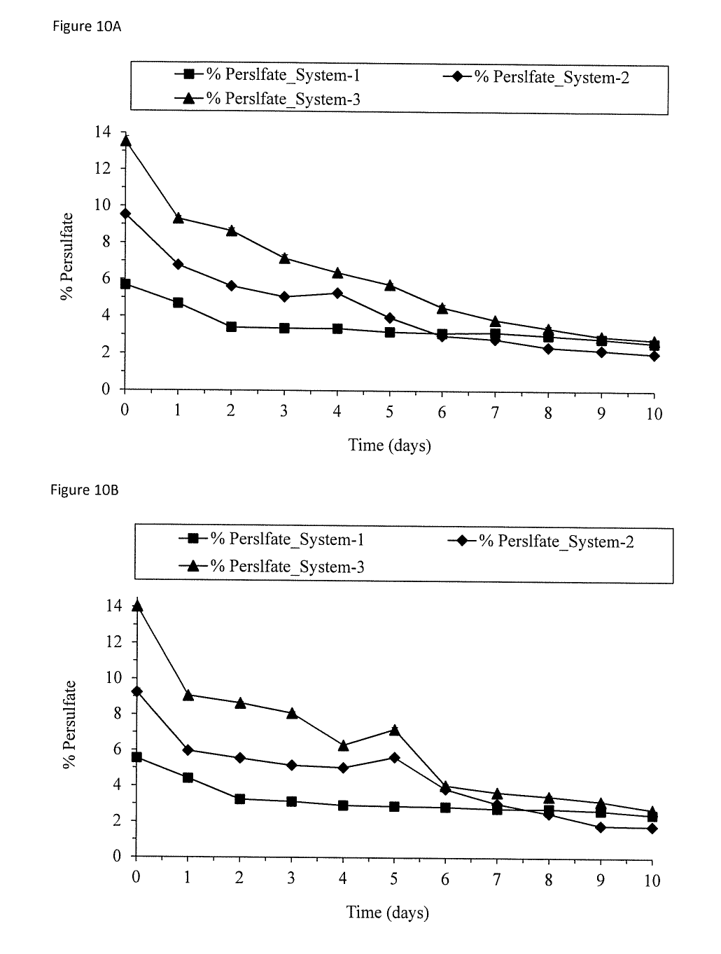

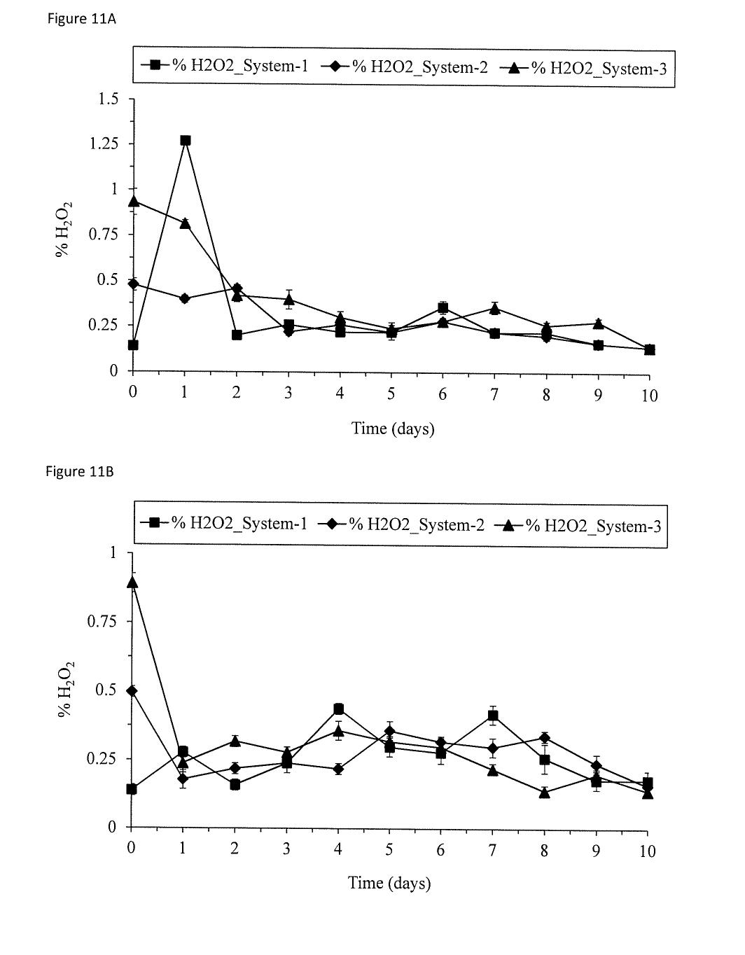

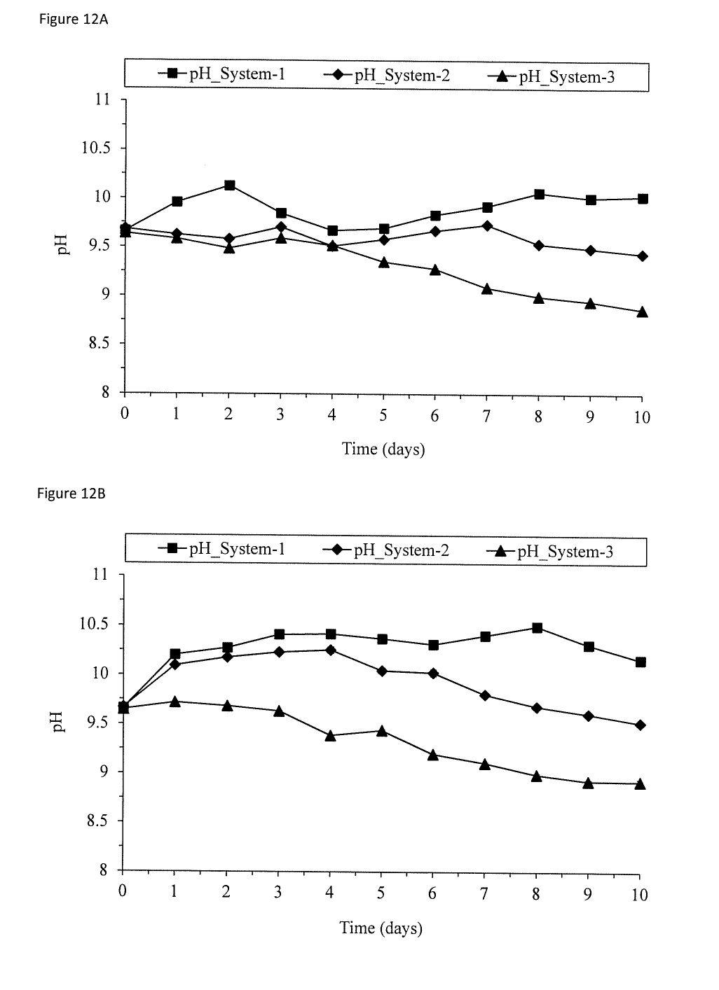

Slow release hydrogen peroxide systems in the presence of the Carson Valley soil improved the lifetime of H₂O₂ to destroy the CT and PCE DNAPLs (FIGS. 11A and 11B). Hydrogen peroxide lifetimes were significantly longer in these systems compared to soil-percarbonate systems (FIGS. 8A and 8B) with a near steady state concentration in these slow release percarbonate-soil systems over 10 days (FIGS. 11A and 11B). Persulfate residuals in these systems declined at successively higher rates from System 3 through 1 (FIGS. 10A and 10B). The trend in pH in the systems was the opposite of the trend in persulfate with pH increasing as the persulfate concentration decreased (FIGS. 12A and 12B). Without being bound by theory, the longer persistence of hydrogen peroxide and persulfate is likely responsible for the improved destruction of CT and PCE DNAPL in the natural soil systems.

The results of this research demonstrate that a slow release percarbonate-persulfate system is effective for destroying CT and PCE DNAPLs.

### CONCLUSIONS

The destruction of a CT and a PCE DNAPL was investigated in several systems including deionized water and a natural soil environment using increasingly complex percarbonate formulations. Sodium percarbonate worked as an effective oxidant for a CT DNAPL destruction but failed to provide effective destruction of a PCE DNAPL. The destruction amount of both a CT and a PCE DNAPL improved significantly when a combination of sodium percarbonate and base activated persulfate was used. Substantial degradation of the PCE and CT DNAPLs was achieved in deionized water. In the presence of the Carson Valley soil, sodium percarbonate failed to provide effective DNAPL destruction, likely because the H₂O₂ concentration decreased rapidly. The use of a slow release percarbonate formulation provided more effective DNAPL destruction, e.g. 37% to 60.5% DNAPL destruction over 10 days.

### Example 2

### Additional Formulations of Oxidizers in Slow Release Matrices

Other stabilized oxidants are formulated for slow release into contaminated subsurface systems. Calcium peroxide is a solid peroxgen that decomposes to hydrogen peroxide through hydrolysis reactions. It is also somewhat short-lived in soil and groundwater systems; therefore, converting it to a slow release formulation enhances its efficacy. Although it is not a common ISCO reagent, sodium peroxymonocarbonate is also stabilized as described herein, enhancing its effectiveness. These stabilized reagents are laboratory tested in the same manner as the stabilized sodium percarbonate-sodium persulfate system; i.e., contaminated soil and groundwater from the site are placed in small reactors, and a range of concentrations are evaluated for contaminant destruction and oxidant longevity.

### REFERENCES

Ahmad M., Teel, A. L., Watts, R. J., 2013. Phenoxide activation of persulfate. Environ. Sci. Technol., 47, (11), 5864-5871.
Bjorsvik, H. R., Merinero, J. A. V., Liguori, L., 2004. Nitroarene catalyzed oxidation with sodium percarbonate or sodium perborate as the terminal oxidant. Tetrahedron Letters, 45(47), 8615-8620.
Bracken, J. D., Tietz, D., 2005. Analysis of oxiClean: An interesting comparison of percarbonate stain removers. J. Chem. Educ., 82 (5), 762-764.
Brusseau, M. L., Rohay, V., Truex, M. J., 2010. Analysis of soil vapor extraction data to evaluate mass-transfer constraints and estimate source-zone mass flux. Ground Water Monit. Remediat., 30 (3), 57-64.
Buxton, G. V., Greenstock, C. L., Helman, W. P., Ross, A. B. (1988).“Critical review of rate constants for reactions of hydrated electrons, hydrogen atoms and hydroxyl radicals (.OH/.O—) in aqueous solution.” J. Phys. Chem. Ref Data, 17(2), 513-886.
Furman, O. S., Teel, A. L., Watts, R. J., 2010. Volume Reduction of Nonaqueous Media Contaminated with a Highly Halogenated Model Compound Using Superoxide. J. Agr. Food Chem., 58 (3), 1838-1843.
Gee, B. W., Bauder, J. W., 1986. Particle-size analysis. In A. Klute et al. (ed.), Methods of soil analysis, Part 1: Physical and Mineralogical Methods. ASA and SSSA, Madison, Wis., 399-404.
Haag, W. R., Yao, C. C. D., 1992. Rate constants for reaction of hydroxyl radicals with several drinking water contaminants. Environ. Sci. Technol. 26, 1005-1013.
Hayon, E., Treinin, A., Wilf, J., 1972. Electronic spectra, photochemistry, and autoxidation mechanism of the sulfitebisulfite-pyrosulfite systems. The SO₂⁻, SO₃⁻, SO₄⁻, and SO₅⁻ radicals. J. Amer. Chem. Soc., 94, 47-57.
Jackson, M. L., Lim, C. H., Zelazny, L. W., 1986. In A. Klute et al. (ed.), Methods of Soil Analysis, Part 1: Physical and Mineralogical Methods. ASA and SSSA, Madison, Wis., 13-124.
Kolthoff, I. M. and Stenger, V. A., 1947. Volumetric analysis, second edition. Volume II: Titration Methods: Acid-Base, Precipitation and Complex Reactions. New York: Interscience Publishers.
Lin, J. M., Liu, M. 2008. Chemiluminescence from the decomposition of peroxymonocarbonate catalyzed by gold nanoparticles. J. Phys. Chem. B, 112 (26), 7850-7855.
Lin, J. M., Liu, M., 2009. Singlet oxygen generated from the decomposition of peroxymonocarbonate and its observation with chemiluminescence method. Spectrochim. Acta. A., 72,126-132.
McKillop, Alexander, Sanderson, William R., 1995. Sodium perborate and sodium percarbonate: Cheap, safe and versatile oxidising agents for organic synthesis. Tetrahedron, 51(22), 6145-6166.
Merker, M. C, Teel, A. L., Watts, R. J., 2012. Economical generation of superoxide: the effects of concentration in a sodium percarbonate system. Conference on Remediation of Chlorinated and Recalcitrant Compounds. Monterey, Calif.
Nelson, D. W., Sommers, L. E., 1982. In A. L. Page et al. (ed.), Methods of Soil Analysis, Part 2: Chemical and Microbiological Methods. ASA and SSSA, Madison, Wis., 539-579.
Neta, P., Madhaven, V., Zemel, H., Fessenden, R. W., 1977. Rate constants and mechanism of reaction of SO4.— with aromatic compounds. J. Amer. Chem. Soc., 99 (1), 163-164.
Smith, B. A., Teel, A. L., Watts, R. J., 2006. Mechanism for the destruction of carbon tetrachloride and chloroform DNAPLs by modified Fenton's reagent. J. Contam. Hydrol., 85(3-4), 229-246.
Smith, W A., Teel, A. L., Watts, R. J., 2009. Destruction of trichloroethylene and perchloroethylene DNAPLs by catalyzed H2O2 propagations (CHP—modified Fenton's reagent). J. Environ. Eng., 135,535-543.
Wada, T., Koga, N., 2013. Chemical Composition of Sodium Percarbonate: An Inquiry-Based Laboratory Exercise. J. Chem. Educ., 90 (8), 1048-1052.
Watts, R. J., Teel, A. L., 2005. Chemistry of modified Fenton's reagent (catalyzed H₂O₂ propagations—CHP) for in situ soil and groundwater remediation. J. Environ. Eng., 131, 612-622.

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A composition for destruction of dense nonaqueous phase liquids, comprising:
a first slow release matrix comprising a first oxidizer which generates superoxide as a transient species, wherein said first oxidizer is released from said first slow release matrix over time;
a second oxidizer which generates hydroxyl radicals as a transient species; and a liquid carrier.

2. The composition of claim 1, wherein said first oxidizer is selected from the group consisting of sodium percarbonate, sodium perborate, and potassium superoxide.

3. The composition of claim 1, wherein said second oxidizer is selected from the group consisting of sodium persulfate, calcium peroxide, sodium peroxymonocarbonate, stabilized hydrogen peroxide, and an organic peroxide.

4. The composition of claim 3, wherein said organic peroxide is ter/-butyl peroxide.

5. The composition of claim 1, wherein said second oxidizer is dissolved in said liquid carrier.

6. The composition of claim 1, wherein said second oxidizer is present in said composition in a second slow release matrix.

7. The composition of claim 1, wherein said second oxidizer is present in said composition in said first slow release matrix.

8. The composition of claim 2, wherein said first oxidizer is sodium percarbonate in a slow release crystalline form.

9. The composition of claim 1, wherein one or both of said first and second slow release matrices are selected from the group consisting of a slow release matrix comprising attapulgite clay, ethyl cellulose, and sodium carboxymethylcellulose;
silicate polymers, paraffins, and crosslinked starch.

10. A method of destroying dense nonaqueous phase liquids, comprising
contacting said dense nonaqueous phase liquids with a composition comprising
a first slow release matrix comprising a first oxidizer which generates superoxide as a transient species, wherein said first oxidizer is released from said first slow release matrix over time; and
a second oxidizer which generates hydroxyl radicals as a transient species;
wherein said step of contacting is performed with a quantity of said composition that is sufficient to destroy said dense nonaqueous phase liquids.

11. The method of claim 10, wherein said dense nonaqueous phase liquids are present in soil.

12. The method of claim 10, wherein said dense nonaqueous phase liquids are present in water.

13. The method of claim 10, wherein said nonaqueous phase liquids are chlorinated organic compounds.

14. The method of claim 13, wherein said chlorinated organic compounds are selected from the group consisting of a chlorinated solvent, coal tar, creosote, a polychlorinated biphenyl (PCB); a chlorobenzene, a chlorophenol, a chloroaniline, hexachlorocyclopentadiene and an extra heavy crude oil with an American Petroleum Institute (API) gravity of less than 10.

15. The method of claim 14, wherein said chlorinated solvent is selected from the group consisting of trichloroethylene, perchloroethylene, 1,1,1-trichloroethane, 1,1,2-trichloroethane, chloroform, methylene chloride, 1,2-dichloroethane, 1,2-dichloropropane, and carbon tetrachloride.

16. The method of claim 14, wherein said chlorobenzene is selected from the consisting of chlorobenzene, 1,2-dichlorobenzene, 1,3-dichlorobenzene and 1,4-dichlorbenzene.

17. The method of claim 14, wherein said chlorophenol is 2-chlorophenol.

18. The method of claim 14, wherein said chloroaniline is 2-chloroaniline.
